(19) United States
(12) Patent Application Publication
(10) Pub. No.: US 2023/0128641 A1
(43) Pub. Date: Apr. 27, 2023

(54) PURGE VALVE ASSEMBLIES

(71) Applicant: HEWLETT-PACKARD DEVELOPMENT COMPANY, L.P., Spring, TX (US)

(72) Inventor: Kundan SINGH, Singapore (SG)

(21) Appl. No.: 17/915,222

(22) PCT Filed: Apr. 16, 2020
(86) PCT No.: PCT/US2020/028526

§ 371 Date: Sep. 28, 2022

(51) Int. Cl. F04B 43/02; B41J 2/175

(52) U.S. Cl. CPC F04B 43/023; B41J 2/17596

(57) ABSTRACT

Disclosed are example purge valve assemblies for a printing system and related methods. In an example, the purge valve assembly includes a valve body to couple to a carriage of the printing system. In addition, the purge valve assembly includes an actuator, an arm, and a diaphragm coupled to the arm and the valve body. The purge valve assembly is to transition between: a first position in which the actuator is disposed at an initial position and the diaphragm is extended outward from the valve body; and second position in which the actuator is translated along an axis from the initial position to slidingly engage with the arm to rotate the arm and depress the diaphragm toward the valve body.

### BACKGROUND

Printing systems may deposit a printing fluid onto print media, print media to produce images, words, symbols, etc. (collectively referred to herein as “images”) thereon. To facilitate the use of such a printing fluid, printing systems may include fluid paths for flowing or transporting the printing fluid throughout the printing system and ultimately to the print media.

### BRIEF DESCRIPTION OF THE DRAWINGS

Various examples will be described below referring to the following figures:

FIG. 1 is a schematic view of a printing system that includes a purge valve assembly according to some examples;

FIG. 2 is a schematic front view of an example purge valve assembly for use within the printing system of FIG. 1 in a first position according to some examples;

FIG. 3 is a schematic top view of the purge valve assembly of FIG. 2 according to some examples;

FIG. 4 is a schematic front view of the purge valve assembly of FIG. 2 in a second position according to some examples;

FIGS. 5 and 6 are schematic sequential side views of the purge valve assembly of FIG. 2 showing the purge valve assembly in the first and second positions; respectively, according to some examples;

FIG. 7 is a cross-sectional view taken along section 7-7 in FIG. 2 according to some examples;

FIG. 8 is a cross-sectional view taken along section 8-8 in FIG. 4 according to some examples;

FIG. 9 is a perspective view of an example of a purge valve assembly for use within the printing system of FIG. 1 according to some examples;

FIG. 10 is a cross-sectional view taken along section 10-10 in FIG. 9 according to some examples; and

FIG. 11 is a flow chart of a method for purging air from a printing fluid path of a printing system according to some examples.

### DETAILED DESCRIPTION

Printing systems may include fluid paths for flowing or transporting printing fluid therethrough, Air or other gases (collectively referred to herein as “air”) may be disposed within the fluid paths of a printing system. During a printing operation, the presence of air within the fluid paths may impede progress of the printing fluid. Specifically, air can encounter resistance within the internal fluid paths of the printing system such that so-called “gas-lock” or “air-lock” can occur, whereby a bubble (or multiple bubbles) of air blocks the fluid flow path such that the flow of printing fluid is stopped (or restricted). Additionally, if air is disposed within the fluid paths of a printing system when the printing system is operated (e.g., to print an image on print media), print quality may be reduced and components of the printing system may even sustain damage so as to reduce an operational life of the components or the printing system.

Accordingly, the examples disclosed herein include purge valve assemblies for printing systems that are to purge gases (e.g., air) from a fluid path(s) within a printing system. In some examples, the purge valve assemblies may include a diaphragm, wherein actuation (e.g., depression and expansion) of the diaphragm purges gases from the fluid path(s). Thus, through use of the purge valve assemblies described herein, air may be effectively removed from the fluid flow path(s) within the printing system so that the flow reliability of printing fluid therein is enhanced and the lifetime of the printing system may be preserved.

As used herein, the term “print media” refers to any surface or material that is to receive a printing fluid thereon to form an image. The term specifically includes paper.

As used herein, the term “printing fluid” refers to any liquid printing fluid that may be used to form an image on print media. The term specifically includes liquid printing agents, such as, for instance, ink.

As used herein, the term elongate refers to objects or members that have a length greater than their width.

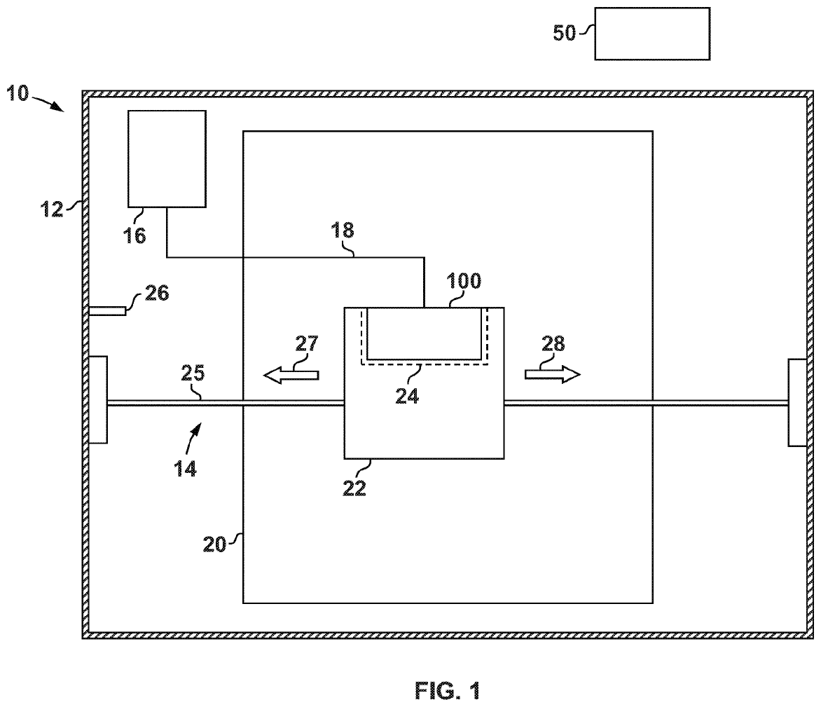

Referring now to FIG. 1, a printing system 10 according to some examples is shown. Generally speaking, the printing system 10 includes a printer housing 12, and a printing assembly 14 disposed within the printer housing 12.

The printing assembly 14 comprises a printing fluid source 16, and a carriage 22. The printing fluid source 16 may comprise a vessel (e.g., tank, bottle, chamber, etc.) or collection of vessels for storing a volume of printing fluid. A tube 18 extends between and is coupled to the printing fluid source 16 and carriage 22. Tube 18 may comprise any suitable conduit for flowing a fluid therethrough. For instance, in some examples, tube 18 may comprise a flexible tube (e.g., a polymer and/or elastomeric tube); however, in other examples, tube 18 may comprise metallic tubing, pipe, channels, and/or any combination thereof.

In the example of FIG. 1, carriage 22 includes a receptacle 24. In this example, a purge valve assembly 100 is initially disposed within the receptacle 24. As will be described in more detail below, during operations, the purge valve assembly 100 is to purge air (or other gases) that may be disposed within the tube 18 (or other portions of the printing assembly 14 that are fluidly coupled to tube 18) so as to improve subsequent printed image quality and preserve the operating life of printing system as previously described above.

Referring still to FIG. 1, in some examples, once the purge valve assembly 100 has drawn air out of the tube 18, the purge valve assembly 100 may be removed from receptacle 24 and replaced with a printhead 50 or other suitable printing fluid deposition device. Thereafter; during printing operations, the printing fluid may be drawn from printing fluid source 16, through tube 18, and into printhead 50 (which is installed on carriage 22 as previously described). Simultaneously, the carriage 22 is translated across print media 20 via a rail 25 or other suitable structure so that printhead 50 may selectively deposit the printing fluid onto print media 20 to form images thereon as previously described. However, because purge valve assembly 100 has previously evacuated air from the printing assembly 14 (e.g., from tube 18), these subsequent printing operations may produce a higher quality image and damage to the components of printing assembly 14 (e.g., such as caused by air flowing within the tube 18 and printhead 50 during a printing operation) may be reduced or avoided entirely.

In some examples, the carriage 22 may receive a plurality of printheads 50, and the printing assembly 14 may further comprise a plurality of printing fluid sources 16, and a plurality of tubes 18 coupled to the plurality of printheads 50, so as to allow the printing assembly 14 to deposit multiple colors of printing fluid onto print media 20 during operations. In these examples, the purge valve assembly 100 may simultaneously purge air from the plurality of tubes 18 that extend between the multiple printing fluid sources 16 and the carriage 22.

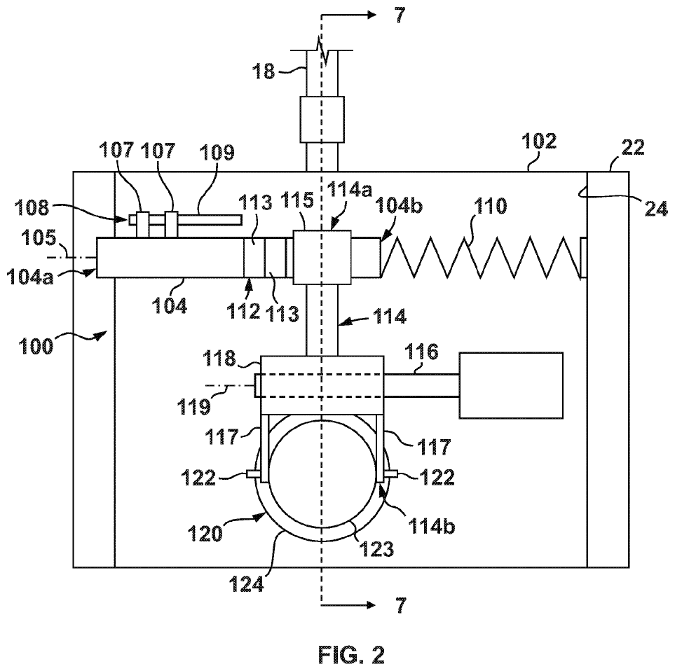

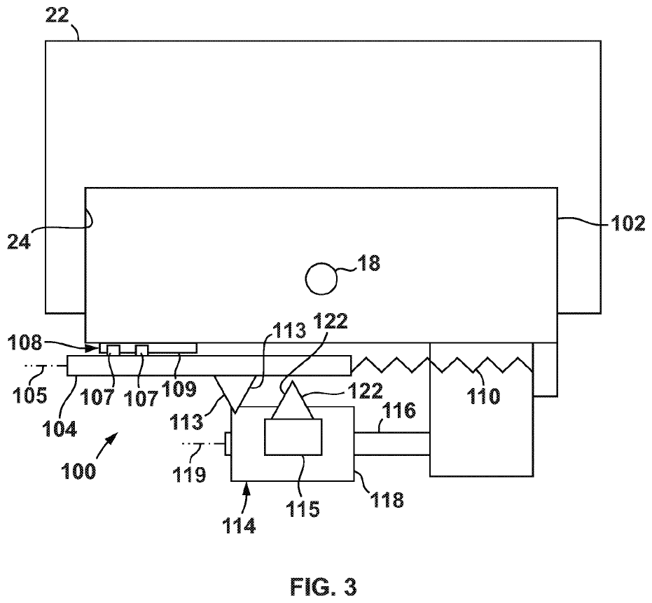

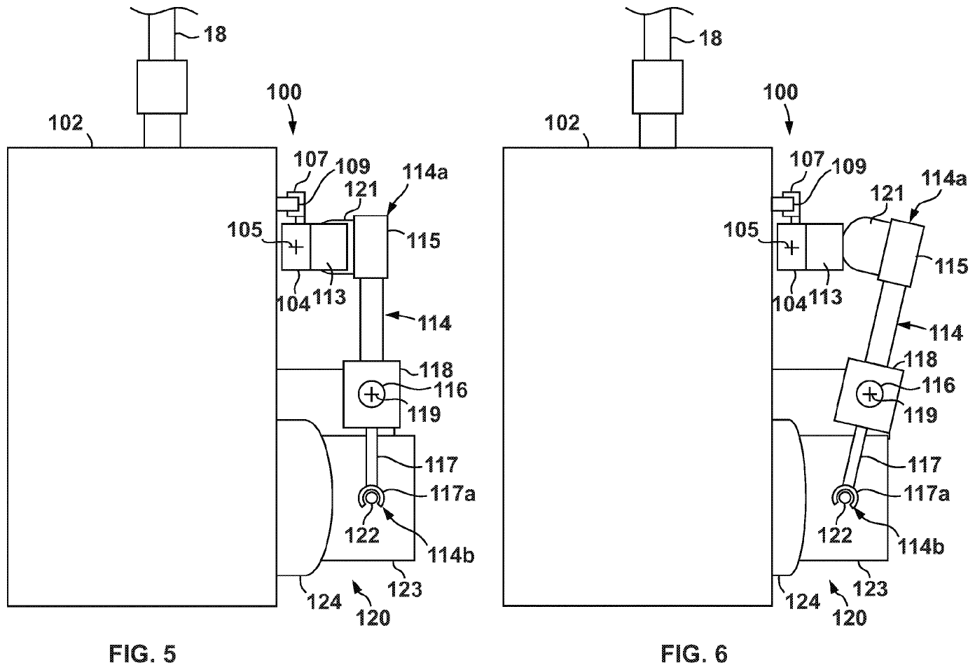

Referring now to FIGS. 2-6, an example purge valve assembly 100 is shown disposed within the receptacle 24 of carriage 22. Generally speaking, purge valve assembly 100 includes a valve body 102, an actuator 104, an arm 114, and a diaphragm assembly 120. It should be noted that FIG. 3 omits the diaphragm assembly 120, and FIGS. 5 and 6 omit receptacle 24 and carriage 22 so as to simplify the drawings.

Referring specifically now to FIGS. 2-4, actuator 104 is an elongate member that includes a central or longitudinal axis 105, a first end 104a, and a second end 104b opposite first end 104a. A projection 112 is disposed on actuator 104, between the ends 104a, 104b that includes a pair of ramped surfaces 113 that extend outward from axis 105 along a non-radial direction relative to axis 105 (e.g., at an angle between 0° and 90° or between 90° and 180° relative to axis 105 as viewed in to the top view of FIG. 3).

Actuator 104 may be movably coupled to valve body 102 via a rail assembly 108. In particular, rail assembly 108 includes rail 109 mounted to valve body 102. Actuator 104 includes a pair of extensions 107 that engage with rail 109. A biasing member 110 is coupled to valve body 102 and is engaged with second end 104b of actuator 104. In this example, biasing member 110 comprises a coiled spring; however, any other suitable biasing member or assembly may be utilized in other examples (e.g., a biased piston, a flat spring, torsional spring, etc.). During operations, biasing member 110 may bias actuator 104 along axis 105 (or a projection thereof).

Referring again to FIGS. 2-6, arm 114 includes an elongate member having a first end 114a and a second end 114b opposite first end 114a. In addition, arm 114 includes an engagement member 115 at first end 114a, a pair of connectors 117 at second end 114b, and a receptacle 118 disposed between ends 114a, 114b (and therefore between engagement member 115 and connectors 117).

As best shown in FIG. 3, engagement member 115 includes a pair of ramped surfaces 121. In some examples, the ramped surfaces 121 may generally correspond to the ramped surfaces 113 of projection 112 on actuator 104. For instance, the ramped surfaces 121 may extend at similar (or possibly equivalent) angles to the ramped surfaces 113. As a result, when arm 114 is mounted to the valve body 102 as shown in FIGS. 2-6, the ramped surfaces 121 may extend in a non-radial direction relative to axis 105 (e.g., at an angle between 0° and 90° or between 90° and 180° relative to axis 105 as viewed in to the top view of FIG. 3).

Referring again to FIGS. 2-6, an elongate shaft 116 is received through receptacle 118. Shaft 116 is mounted to valve body 102 and includes a central or longitudinal axis 119 that defines an axis of rotation for the arm 114 relative to valve body 102. Thus, during operations receptacle 118 may slidingly engage with shaft 116 so as to allow arm 114 to pivot about axis 119. In some examples (e.g., such as the example of FIGS. 2-6), the axes 105 and 119 may be parallel and radially offset from one another.

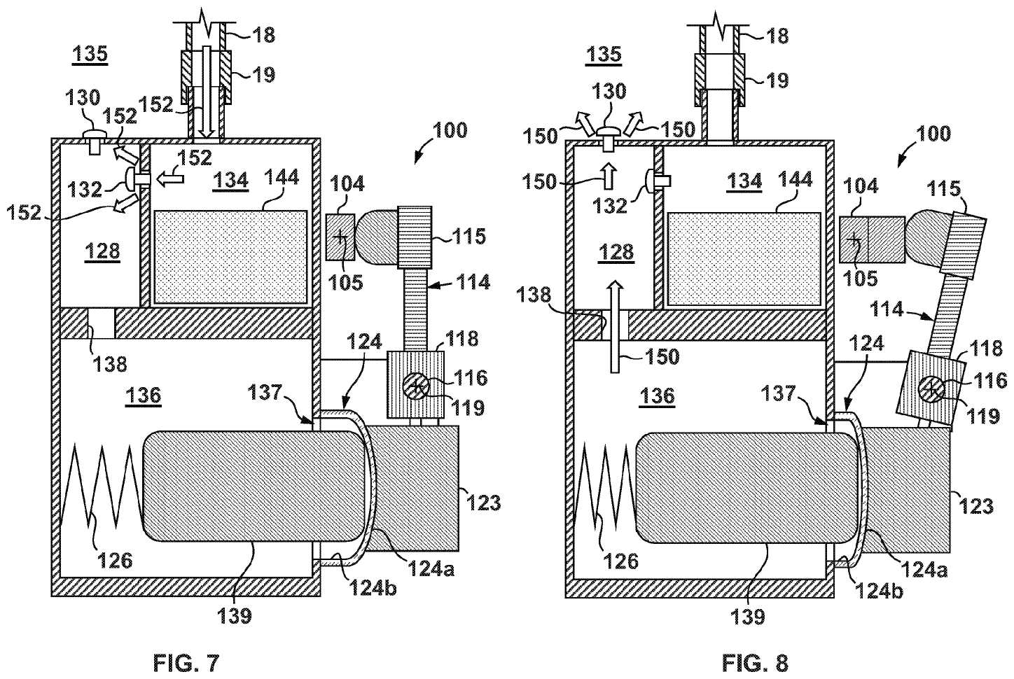

Diaphragm assembly 120 includes a diaphragm 124 disposed about a port or hole (not shown in FIGS. 2-6 but see port 137 in FIGS. 7 and 8) in valve body 102, and a plunger 123 coupled to diaphragm 124. The diaphragm 124 comprises a sheet or membrane of compliant material. The diaphragm 124 forms a partition over the port in valve body 102 (see e.g., port 137 in FIGS. 7 and 8) that is to deform when an unequal force (or pressure) is placed thereacross. In some examples, the diaphragm may comprise an elastomeric material (e.g., natural or synthetic rubber); however, any suitable material that may elastically deform when placed under load (e.g., such as the load exerted on the diaphragm 124 by the arm 114 as described in more detail below), while maintaining a sealing engagement with the port (e.g., port 137 in FIGS. 7 and 8) in the valve body 102 may be utilized in various examples.

A pair of projections 122 extend outward from plunger 123 that are pivotably coupled to connectors 117 on arm 114. In particular, as best shown in FIGS. 5 and 6, projections 122 are received within receptacles 117a that are formed on connectors 117. Projections 122 may be generally cylindrical in shape, and receptacles 117a may be formed so as to partially or wholly surround an outer surface of the projections 122. Thus, during operations, receptacles 117a may freely pivot about the projections 122 as arm 114 pivots or rotates about axis 119 of shaft 116 as previously described above.

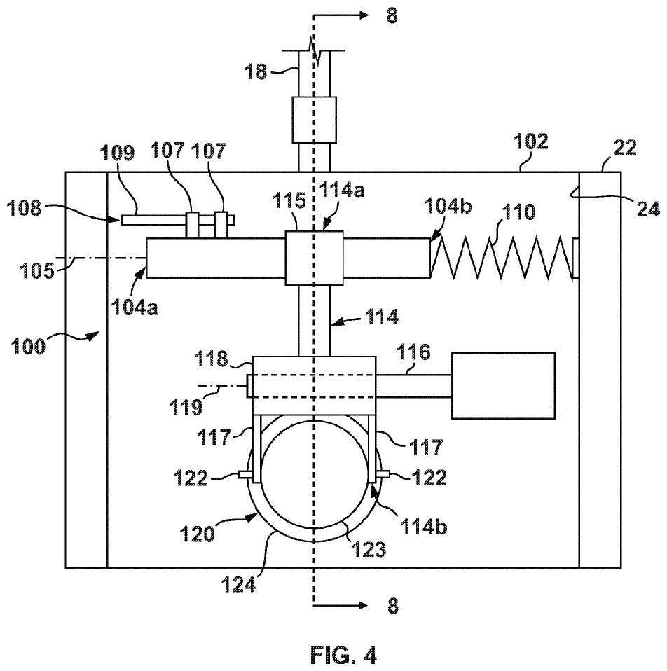

Referring now to FIGS. 2, 4, 5, and 6, during operations, purge valve assembly 100 is transitioned between a first position (shown in FIGS. 2 and 5) and a second position (shown in FIGS. 4 and 6). In particular, when purge valve assembly 100 is in the first position, the actuator 104 is disposed in an initial position so that ramped surfaces 113 on projection 112 are spaced from ramped surfaces 121 on engagement member 115 along the axis 105 in the manner shown in FIG. 2 (see also FIG. 3). When it is desired to actuate the purge valve assembly 100 from the first position of FIGS. 2 and 5 to the second position of FIGS. 4 and 6, the actuator 104 is first translated from the initial position shown in FIG. 2 along axis 105 (or a projection thereof) to the position shown in FIG. 4. Specifically, during the translation, the actuator 104 is moved along a linear path that is coaxially aligned or parallel with axis 105 so as to compress biasing member 110. In addition, during the translation of actuator 104 from the position of FIG. 2 to the position of FIG. 4, one of the ramped surfaces 113 on projection 112 is slidingly engaged along one of the ramped surfaces 121 on engagement member 115 of arm 114. The sliding engagement of the ramped surfaces 113, 121 causes arm 114 to rotate about axis 119 of shaft 116 so that first end 114a of arm 114 is generally moved away from valve body 102 and second end 114b of arm 114 is generally moved toward valve body 102 (see e.g., the sequence from FIG. 5 to FIG. 6). Because the receptacles 117a of connectors 117 are pivotably coupled to projections 122 on plunger 123 of diaphragm assembly 120, as the second end 114b of arm 114 is moved toward valve body 102, the diaphragm 124 is depressed inward toward valve body 102 (see e.g., the sequence from FIG. 5 to FIG. 6).

Accordingly, when the purge valve assembly 100 is transitioned from the first position (FIGS. 2 and 5) to the second position (FIGS. 4 and 6), the diaphragm 124 is depressed inward toward the valve body 102. Conversely, when the purge valve assembly 100 is transitioned from the second position (FIGS. 4 and 6) to the first position (FIGS. 2 and 5), the arm 114 is pivoted about axis 119 so that the first end 114a is moved toward the valve body 102 and second end 114b is moved away from valve body 102, and therefore the diaphragm 124 is expanded (or released) away from the valve body 102.

Referring now to FIGS. 1, 2 and 4, in some examples, in order to actuate the purge valve assembly 100 between the first position (see e.g., FIGS. 2 and 5) and second position (see e.g., FIGS. 4 and 6) as described above, the carriage 22 may be translated within the printer housing 12 (e.g., via rail 25) so as to engage actuator 104 with a surface 26 disposed within printer housing 12, and thereby translate the actuator 104 along axis 105 as previously described. In particular, movement of the carriage 22 toward surface 26 within printer housing 12 eventually causes surface 26 to engage with first end 104a of actuator 104. Continued movement of carriage 22 toward surface 26 then drives the translation of actuator 104 along axis 105 thereby resulting in the sliding engagement of ramped surfaces 113, 121, rotation of arm 114, and depression of diaphragm 124 as previously described above. Thereafter, the carriage 22 is translated away from surface 26 so as to disengage first end 104a of actuator 104 from surface 26. Thereafter, the biasing force supplied by biasing member 110 on second end 104b of actuator 104 may drive actuator 104 back along axis 105 toward the initial, unactuated position of FIG. 2, such that arm 114 may rotate about axis 119 to allow diaphragm 124 to expand away from valve body 102 as previously described. As will be described in more detail below, diaphragm 124 and/or arm 114 may be biased to the first position of FIGS. 2 and 5 (e.g., such as via a biasing member 126 shown in FIGS. 7 and 8, and/or a torsional biasing member to rotationally bias the arm 114 about axis 119).

Therefore, during operations, the carriage 22 may traverse along rail 25 in a first direction 27 (see FIG. 1) to engage the actuator 104 with surface 26 and thereby transition the purge valve assembly 100 from the first position (FIGS. 2 and 5) to the second position (FIGS. 4 and 6), Thereafter, the carriage 22 may traverse along rail in a second direction 28 that is opposite the first direction 27 so as to disengage the actuator 104 from surface 26 and thereby transition the purge valve assembly 100 from the second position (FIGS. 4 and 6) to the first position (FIGS. 2 and 5).

The surface 26 may comprise any surface or structure that is disposed within the printer housing 12. In some examples, the surface 26 may be defined by the materials making up printer housing 12 itself, or may comprise a surface of a component that is mounted within printer housing 12.

When the purge valve assembly 100 is transitioned between the first position and second position to depress and expand the diaphragm 124 as previously described above (see e.g., FIGS. 5 and 6), air may be purged or evacuated from the tube 18 and thereby replaced with printing fluid. Further details of the movement of fluid within the purge valve assembly 100 when transitioning between the first position and second position are now described in more detail below with reference to FIGS. 7 and 8.

Referring now to FIGS. 7 and 8, valve body 102 defines a plurality of chambers therein. Specifically, valve body 102 includes a first chamber 136, a second chamber 128, and a third chamber 134. The first chamber 136 is fluidly coupled to second chamber 128 via an opening 138 so that fluid (e.g., air, printing fluid, etc.) may freely flow between chambers 136, 128 through the opening 138 during operations. In some examples, the first chamber 136 and second chamber 128 may be a singular chamber without a wall or partition disposed therebetween. The second chamber 128 and third chamber 134 are in fluid communication via a first or suction valve assembly 132. In addition, the second chamber 128 is in fluid communication with an environment 135 via a second or discharge valve assembly 130.

The valve assemblies 130, 132 are one-way valves (e.g., such as so-called umbrella valves) that allow fluid flow therethrough in a single direction. Specifically, in this example, the discharge valve assembly 130 is arranged between the second chamber 128 and environment 135 so as to allow fluid to flow out of second chamber 128 into the environment 135 (e.g., such as when the pressure within the second chamber 128 is greater than the pressure within the environment 135), but to prevent fluid from flowing from the environment 135 into the second chamber 128. In some examples, the environment 135 is at atmospheric conditions so that the discharge valve assembly 130 is to allow fluid to flow from the second chamber 128 to the environment 135 when the pressure within the second chamber 128 is greater than atmospheric pressure.

Also, in this example, the suction valve assembly 132 is arranged between the second chamber 128 and third chamber 134 so as to allow fluid to flow out of third chamber 134 into the second chamber 128 (e.g., such as when the pressure within the third chamber 134 is greater than the pressure within the second chamber 128), but to prevent fluid from flowing from the second chamber 128 into the third chamber 134.

The third chamber 134 is in fluid communication with a tube 18 via a connector 19. As a result, fluid (e.g., air, printing fluid, etc.) may flow into the third chamber 134 from the tube 18 via the connector 19 during operations. An absorbent material 144 is disposed within the third chamber 134 that is to absorb printing fluid or other liquids that may be emitted into the third chamber 134 (e.g., from tube 18) during operations. In some examples, the absorbent material 144 may comprise a sponge (e.g., natural sponge, synthetic sponge, etc.).

Referring still to FIGS. 7 and 8, a port 137 extends through the wall of valve body 102 into the first chamber 136. Diaphragm 124 is sealingly engaged about port 137 so that fluid is prevented or restricted from flowing out of the first chamber 136 via the port 137 and diaphragm 124 during operations. Thus, diaphragm 124 defines a first or outer side 124a that faces outward from first chamber 136 and that is coupled to plunger 123, and a second or inner side 124b that faces inward to the first chamber 136. Thus, diaphragm 124 forms or defines a portion of the first chamber 136. During operations, a depression or expansion of the diaphragm 124 is to decrease and increase, respectively, a fluid volume within the first chamber 136 during operations.

A ram 139 is disposed within first chamber 136 that is biased into engagement with the inner surface 124b of diaphragm 124 via a biasing member 126. In this example, biasing member 126 may comprise a coiled spring; however, in other examples, biasing member 126 may comprise any suitable biasing device or assembly (e.g., such as described above for biasing member 110). Together, the ram 139 and biasing member 126 bias the diaphragm 124 away from the valve body 102 (e.g., toward the first position shown in FIGS. 5 and 7).

Referring briefly to FIGS. 5-8, because projections 122 on plunger 123 are pivotably connected to connectors 117 of arm 114 (e.g., via receptacles 117a), ram 139 and biasing member 126 also rotationally bias the arm 114 about axis 119 toward the first position of FIGS. 5 and 7. As previously described, in some example, purge valve assembly 100 may additionally or alternatively include a torsional biasing member (e.g., such as a torsional spring) to rotationally bias the arm 114 about axis 119 as described above.

Referring now to FIGS. 5-8, during operations, as the purge valve assembly 100 is transitioned from the first position shown in FIGS. 5 and 7 to the second position shown in FIGS. 6 and 8, the arm 114 is rotated about axis 119 so as to depress the diaphragm 124 toward valve body 102 as previously described. As the diaphragm 124 is depressed inward toward valve body 102 and port 137, the volume of the first chamber 136 is decreased, and the pressure within first chamber 136 is increased. Because first chamber 136 is in fluid communication with second chamber 128 via opening 138, the pressure within second chamber 128 is simultaneously increased when diaphragm 124 is depressed inward toward valve body 102. Eventually, the pressure within the second chamber 128 and first chamber 136 rise above the pressure of the environment 135 so that discharge valve assembly 130 is opened (see e.g., FIG. 8) and fluid (e.g., air) is emitted from second chamber 128 into environment 135. Simultaneously, as the pressure within the first chamber 136 and second chamber 128 rise during depression of the diaphragm 124 as previously described, the suction valve assembly 132 closes so as to prevent fluid flow from the second chamber 128 into the third chamber 134. Arrows 150 in FIG. 8 show the general flow of fluid (e.g., air) within valve body 102 as diaphragm 124 is depressed as described above.

Subsequently, as the purge valve assembly 100 is transitioned from the second position shown in FIGS. 6 and 8 to the first position shown in FIGS. 5 and 7, the biasing member 126 and ram 139 within first chamber 136 urge diaphragm 124 outward or away from valve body 102 and port 137 so as to rotate the arm 114 back to its initial position of FIGS. 5 and 7. As the diaphragm 124 is expanded outward from valve body 102 and port 137, the volume of the first chamber 136 is increased, and the pressure within first chamber 136 is decreased. Again, because first chamber 136 is in fluid communication with second chamber 128 via opening 138, the pressure within second chamber 128 is simultaneously decreased when diaphragm 124 is expanded outward from valve body 102. Eventually, the pressure within the second chamber 128 and first chamber 136 fall below the pressure of the third chamber 134 so that suction valve assembly 132 is opened (see e.g., FIG. 7) and fluid (e.g., air) is flowed from third chamber 134 into second chamber 128. The flow of air from the third chamber 134 to the second chamber 128 also generates a vacuum within the connector 19 and tube 18 so that fluid (e.g., including air, printing fluid, etc.) is drawn from the tube 18 through the connector 19 and into the third chamber 134. If printing fluid is drawn out of the tube 18 into the third chamber 134, it may be absorbed into the absorbent member 144 so as to prevent or restrict it from advancing out of the third chamber 134 into the second chamber 128 and first chamber 136. Simultaneously, as the pressure within the first chamber 136 and second chamber 128 falls during expansion of the diaphragm 124 as previously described, the discharge valve assembly 130 closes so as to prevent fluid flow from the second chamber 128 into the environment 135. Arrows 152 in FIG. 7 show the general flow of fluid (e.g., air) within valve body 102 as diaphragm 124 is expanded as described above.

Therefore, referring now to FIGS. 2 and 4-8, as the purge valve assembly 100 is transitioned from the second position of FIGS. 4, 6, 8 to the first position of FIGS. 2, 5, 7, air may be drawn into the valve body 102 from tube 18. In addition, as the purge valve assembly 100 is transitioned from the first position of FIGS. 2, 5, 7 to the second position of FIGS. 4, 6, 8, air purged from the tube 18 is expelled from the valve body 102. Accordingly, cycling the purge valve assembly 100 between the first position (FIGS. 2, 7) and the second position (FIGS. 4, 6, 8) may purge air from the tube 18, so that subsequent printing operations may be improved. In some examples, the purge valve assembly 100 may be cycled between the first position (FIGS. 2, 5, 7) and the second position (FIGS. 4, 6, 8) a predetermined number of times (e.g., by a repeatedly traversing the carriage 22 along the direction 27, 28 as previously described above and shown in FIG. 1), to ensure that all (or substantially all) of the air has been purged from tube 18.

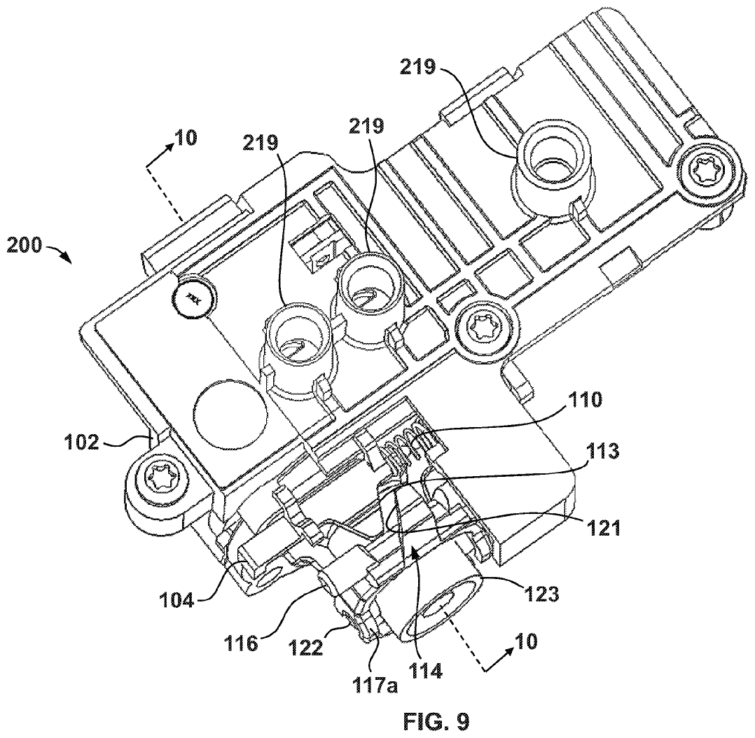

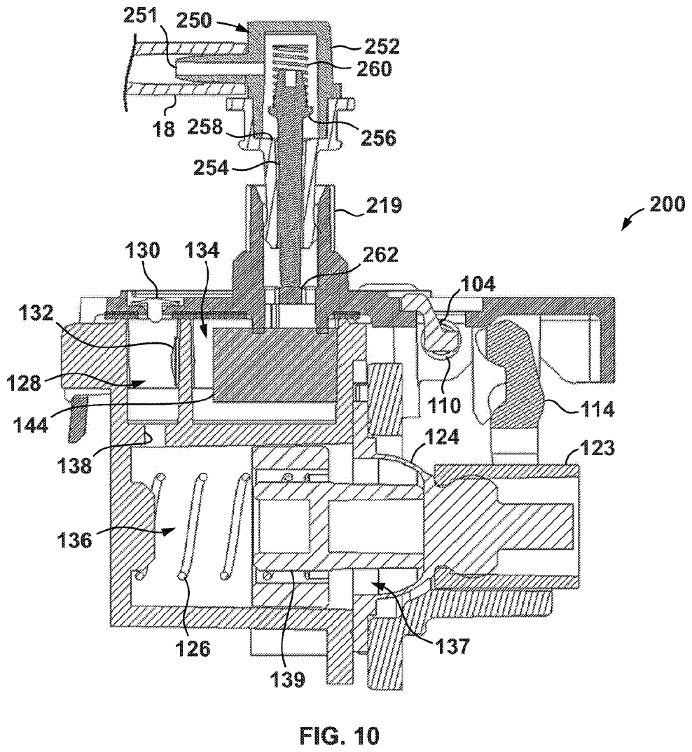

As described above, in some examples, a purge valve assembly (e.g., purge valve assembly 100) may simultaneously purge air from a plurality of tubes (e.g., tubes 18) coupled to a plurality of separate printing fluid sources (e.g., printing fluid source 16). Referring now to FIGS. 9 and 10, a purge valve assembly 200 that may be utilized within the printing system 10 of FIG. 1 is shown. Generally speaking, purge valve assembly 200 includes many shared components with the purge valve assembly 100 shown in FIGS. 2-8. As a result, any components of the purge valve assembly 200 that are shared with the purge valve assembly 100 are identified with the same reference numerals and the description below is directed to the features of purge valve assembly 200 that is/are different from the purge valve assembly 100.

Generally speaking, the purge valve assembly 200 may be utilized to simultaneously purge air from a plurality of different printing fluid tubes (e.g., tube 18) within a printing system (e.g., printing system 10) during operations. Thus, as shown in FIG. 9, a plurality of connectors or ports 219 are disposed on the valve body 102 so as to provide a plurality of connection points for the plurality of printing fluid tubes (e.g., tube 18) during operations. Referring specifically to FIG. 10, the plurality of connectors 219 are in fluid communication with the third chamber 134 (note: a single one of the connectors 219 is shown in FIG. 10 based on the location of the cross-section 10-10 in FIG. 9). During operations, the purge valve assembly 200 is transitioned between the first and second positions so as to depress and expand the diaphragm 124 as previously described above for purge valve assembly 100. Thus, during these operations, air is simultaneously purged from the plurality of printing fluid tubes (e.g., tube 18) into the third chamber 134 and then is emitted from second chamber 128 via discharge valve assembly 130 as previously described. Thus, a detailed description of these operations is not repeated in the interests of brevity.

In addition, as best shown in FIG. 10, tubes (e.g., such as the tube 18 shown in FIG. 10) may each be coupled to connectors 219 via a corresponding valve 250. Generally speaking valve 250 may prevent the flow of fluid out of the tube 18 when tube 18 is disconnected from connector 219 (e.g., such as when replacing a printhead or multiple printheads in place of the purge valve assembly 100, 200 on the carriage 22 following air purging operations as previously described above). As shown in FIG. 10, valve 250 includes a housing 252, and a valve member 254 disposed within the housing 252. The valve member 254 includes a shoulder 256 that is biased into a valve seat 258 within the housing 252 via a biasing member 260 (e.g., a coiled spring) when valve 250 is disconnected from connector 219. Tube 18 is coupled to housing 252 via a connector 251 so that fluid within the tube 18 (e.g., air, printing fluid, etc.) may flow into housing 252 via connector 251 during operations. When valve 250 is engaged with connector 219, the valve member 254 is engaged with a shoulder 262 within the connector 219 so that shoulder 256 is translated away from valve seat 258 so as to allow fluid communication between the tube 18 and the connector 219 (and thus ultimately third chamber 134 within valve body 102).

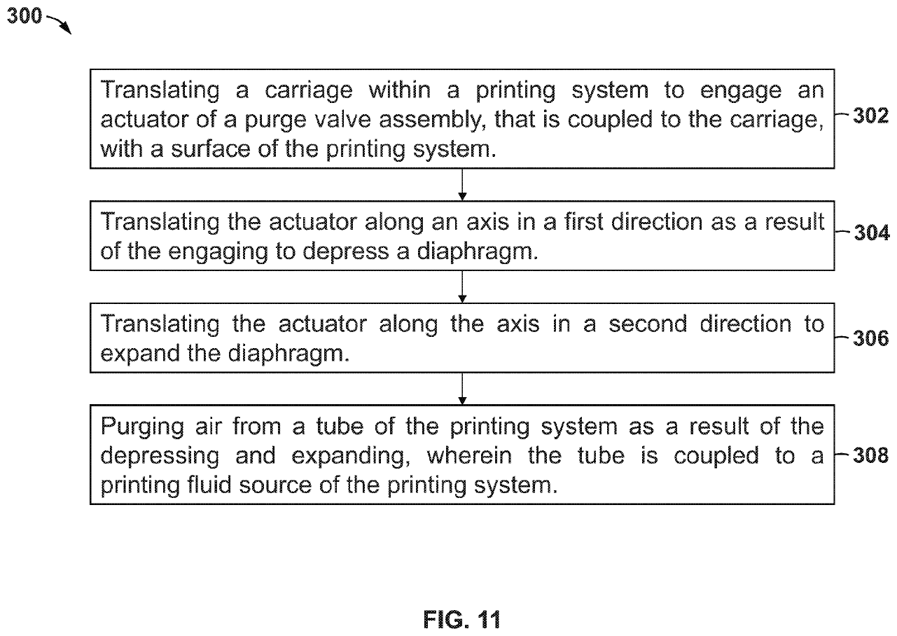

Referring now to FIG. 11, a method 300 for purging air from a printing fluid tube of a printing system is shown. In some examples, method 300 may be performed with any one of the purge valve assemblies 100, 200 previously described above. Thus, in describing method 300, reference may be made to the features of purge valve assemblies 100, 200 previously described above (see e.g., FIGS. 2-10). However, it should be appreciated that method 300 may be performed with other components and assemblies. As a result, any reference to the purge valve assemblies 100, 200 is intended to further explain the features of method 300 and should not be interpreted as limiting the application of method 300 in a general sense.

Initially, method 300 includes translating a carriage within a printing system to engage an actuator of a purge valve assembly, that is coupled to the carriage, with a surface of the printing system at block 302. For instance, as previously described above, the carriage 22 of printing system 10 may be translated within printer housing 12 along a rail 25 in the first direction 27 (FIG. 1) such that actuator 104 (FIG. 2) eventually engages with surface 26 within printer housing 12. Next method 300 includes translating the actuator along an axis in a first direction as a result of the engaging to depress a diaphragm at block 304. For instance, when the actuator 104 is engaged with the surface 26 within printer housing 12 as a result of the translation of the carriage 22 in the first direction 27 (FIGS. 1 and 2), the actuator 104 is translated along axis 105 from a first or initial position (FIG. 2) to a second position (FIG. 4) as generally described above. The diaphragm 124 of purge valve assembly 100 may be depressed as a result of translating the actuator 104 via the sliding engagement of the ramped surfaces 113, 122 and pivoting of arm 114 about axis 119 as previously described above. Next, method 300 includes translating the actuator along the axis in a second direction to expand the diaphragm at block 306. For instance, when the carriage 22 is translated in the second direction 28 (FIG. 1) such the actuator 104 is disengaged from the surface 26, the biasing member 110 may translate the actuator 104 along axis 105 from the second position (FIG. 4) back to the initial position (FIG. 2). This translation of the actuator 104 disengages ramped surfaces 113, 122 and therefore allows the arm 114 to pivot about axis 119 via the biasing force exerted on diaphragm 124 and arm 114 by biasing member 126 so that diaphragm 124 is expanded outward from valve body 102 (see e.g., FIGS. 7 and 8). Finally, method 300 includes purging air from a tube of the printing system as a result of the depressing and expanding at block 308. For instance, in the purge valve assembly 100, the depression and subsequent expansion of diaphragm 124 may purge air from the tube 18 (e.g., as shown in FIGS. 7 and 8 and described above).

The examples disclosed herein have provided purge valve assemblies (e.g., 100, 200) that allow gases (e.g., air) to be purged from fluid paths (e.g., tube 18) or a printing system (e.g., 10). Thus, through the use of the purge valve assemblies described herein, a print quality of the printing system may be improved. Additionally, damage to components of the printing system may be reduced or prevented so as to extend an operational life of the components or the printing system.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the discussion above and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “radial” and “radially” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value. As used herein, the terms “downstream” and “upstream” are used to refer to the arrangement of components and features within a printer or scanning device with respect to the “flow” of media through the printer or scanning device during operations. Thus, if a first component of such a device receives media after it is output from a second component of the device during operations, then the first component may be said to be “downstream” of the second component and the second component may be said to be “upstream” of the first component.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A purge valve assembly for a printing system, the purge valve assembly comprising:
a valve body that to couple to a carriage of the printing system;
an actuator;
an arm; and
a diaphragm coupled to the arm and the valve body;
wherein the purge valve assembly is to transition between:
a first position in which the actuator is disposed at an initial position and the diaphragm is extended outward from the valve body; and
a second position in which the actuator is translated along an axis from the initial position to slidingly engage with the arm to rotate the arm and depress the diaphragm toward the valve body.

2. The purge valve assembly of claim 1, comprising a biasing member that is to bias the diaphragm away from the valve body when the purge valve assembly is in the first position and the second position.

3. The purge valve assembly of claim 1, comprising:
a first chamber within the valve body; and
a first valve coupled between the first chamber and an environment surrounding the valve body,
wherein the first valve is to allow fluid to flow out of the first chamber into the environment when the purge valve assembly is transitioned from the first position to the second position, and
wherein the first valve is to prevent fluid flow into the first chamber from the environment when the purge valve assembly is transitioned from the second position to the first position.

4. The purge valve assembly of claim 3, comprising:
a second chamber within the valve body; and
a second valve coupled between the first chamber and the second chamber,
wherein the second valve is to allow fluid to flow from the second chamber to the first chamber when the purge valve assembly is transitioned from the second position to the first position, and
wherein the second valve is to prevent fluid flow from the first chamber to the second chamber when the purge valve assembly is transitioned from the first position to the second position.

5. The purge valve assembly of claim 1, wherein the actuator comprises a first ramped surface and the arm comprises a second ramped surface, and wherein when the purge valve assembly is transitioned from the first position to the second position, the first ramped surface is slidingly engaged along the second ramped surface.

6. The purge valve assembly of claim 5, comprising a biasing member to bias the actuator toward the initial position when the purge valve assembly is in the first position and the second position.

7. A printing system, comprising:
a printer housing;
a printing assembly disposed within the printer housing, wherein the printing assembly comprises:
a carriage to receive a printhead therein;
a tube coupled to the carriage, wherein the tube is to be coupled to a printing fluid source; and
a purge valve assembly disposed on the carriage, wherein the purge valve assembly comprises:
a valve body fluidly coupled to the tube;
a diaphragm coupled to the valve body;
an actuator comprising a first ramped surface; and
an arm comprising a second ramped surface, wherein the arm is coupled to the diaphragm such that rotation of the arm about an axis of rotation is to actuate the diaphragm;
wherein translation of the carriage within the printer housing is to engage the actuator with a surface in the printer housing to thereby translate the actuator so as to slidingly engage the first ramped surface along the second ramped surface, rotate the arm about the axis of rotation, and actuate the diaphragm to purge air from the tube into the valve body.

8. The printing system of claim 7, wherein the valve body comprises:
a first chamber in fluid communication with the diaphragm; and
a first valve coupled between the first chamber and an environment surrounding the valve body,
wherein the first valve is to allow fluid flow from the first chamber into the environment and prevent fluid flow from the environment into the first chamber.

9. The printing system of claim 8, wherein the valve body comprises:
a second chamber in fluid communication with the tube; and
a second valve coupled between the first chamber and the second chamber,
wherein the second valve is to allow fluid flow from the second chamber to the first chamber and prevent fluid flow from the first chamber to the second chamber.

10. The printing system of claim 9, wherein the purge valve assembly comprises a first biasing member to bias the diaphragm away from the valve body.

11. The printing system of claim 10, wherein the purge valve assembly comprises a second biasing member to bias the first ramped surface away from the second ramped surface.

12. A method, comprising:
translating a carriage within a printing system to engage an actuator of a purge valve assembly, that is coupled to the carriage, with a surface of the printing system;
translating the actuator along an axis in a first direction as a result of the engaging to depress a diaphragm;
translating the actuator along the axis in a second direction to expand the diaphragm; and
purging air from a tube of the printing system as a result of the depressing and expanding, wherein the tube is coupled to a printing fluid source of the printing system.

13. The method of claim 12, comprising:
sliding a first ramped surface on the actuator along a second ramped surface on an arm while translating the actuator;
rotating the arm as a result of the sliding; and
depressing the diaphragm with the arm as a result of the rotating.

14. The method of claim 13, comprising biasing the diaphragm against the depressing with a first biasing member.

15. The method of claim 14, comprising biasing the actuator against the translating with a second biasing member.
